(19) United States
(12) Patent Application Publication
(10) Pub. No.: US 2023/0099718 A1
(43) Pub. Date: Mar. 30, 2023

(54) INFORMATION PROCESSING DEVICE, INFORMATION PROCESSING SYSTEM, AND STORAGE MEDIUM

(71) Applicant: TOYOTA JIDOSHA KABUSHIKI KAISHA, Toyota-shi (JP)

(72) Inventors: Xiao SHAO, Tokyo (JP); Lei ZHONG, Tokyo (JP); Jing MA, Yokohama-shi (JP)

(73) Assignee: TOYOTA JIDOSHA KABUSHIKI KAISHA, Toyota-shi (JP)

(21) Appl. No.: 17/951,780

(22) Filed: Sep. 23, 2022

(30) Foreign Application Priority Data
Sep. 30, 2021 (JP) 2021-162029

(51) Int. Cl. H04W 36/32; H04W 36/08

(52) U.S. Cl. CPC H04W 36/32; H04W 36/08

(57) ABSTRACT

An information processing system includes: a first device provided with a first storage unit that stores base station topology information including base station information relating to a base station that communicates with a vehicle in a traveling route of the vehicle and information defining the traveling route along which the vehicle moves based on at least one of design information and statistical information included in the base station information, and a first processor that acquires handover information between the base station and a communication unit provided in the vehicle and stores the handover information in the first storage unit; and a second device provided with a second processor that acquires the base station topology information and the handover information from the first storage unit of the first device, associates the handover information with the base station topology information, and determines location information and movement direction information of the vehicle.

### CROSS-REFERENCE TO RELATED APPLICATION

This application claims priority to Japanese Patent Application No. 2021-162029 filed on Sep. 30, 2021, incorporated herein by reference in its entirety.

### BACKGROUND

### 1. Technical Field

The present disclosure relates to an information processing device, an information processing system, and a storage medium.

### 2. Description of Related Art

U.S. Pat. No. 8,655,544 discloses a technique for collecting proximity communication information between a plurality of mobile phones or other mobile terminals and a vehicle to a central server and determining a mileage traveled by the vehicle.

### SUMMARY

There has been a demand for a technique that allows determination of a moving direction of a vehicle, in addition to location information of the vehicle, based on information acquired from a base station.

The present disclosure provides an information processing device, an information processing system, and a storage medium capable of determining a position and a moving direction of a vehicle based on information acquired from a base station.

An information processing device according to the present disclosure includes a processor that acquires base station topology information in a base station that communicates with a vehicle in a traveling route of the vehicle based on at least one of design information and statistical information of the base station, and associates handover information between a communication unit provided in the vehicle and the base station with the base station topology information defining the traveling route along which the vehicle moves, and determines location information and movement direction information of the vehicle.

An information processing system according to the present disclosure includes: a first device provided with a first storage unit that stores base station topology information including base station information relating to a base station that communicates with a vehicle in a traveling route of the vehicle and information defining the traveling route along which the vehicle moves based on at least one of design information and statistical information included in the base station information, and a first processor that acquires handover information between the base station and a communication unit provided in the vehicle and stores the handover information in the first storage unit; and a second device provided with a second processor that acquires the base station topology information and the handover information from the first storage unit of the first device, associates the handover information with the base station topology information, and determines location information and movement direction information of the vehicle.

A storage medium according to the present disclosure stores a program that causes a processor to acquire base station topology information in a base station that communicates with a vehicle in a traveling route of the vehicle based on at least one of design information and statistical information of the base station, and associate handover information between a communication unit provided in the vehicle and the base station with the base station topology information defining the traveling route along which the vehicle moves, and determine location information and movement direction information of the vehicle.

According to the present disclosure, it is possible to determine the position and the moving direction of the vehicle based on the information acquired from the base station.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing a configuration of an information processing system according to an embodiment;

FIG. 2 is a block diagram schematically illustrating a configuration of a management server according to an embodiment;

FIG. 3 is a block diagram schematically illustrating a configuration of a communication carrier server according to an embodiment;

FIG. 4 is a block diagram schematically showing the configuration of a vehicle according to the embodiment;

FIG. 5 is a flowchart for explaining a traveling determination method of a vehicle according to the embodiment;

FIG. 6 is a diagram for explaining a determination method of the location information and the moving direction of the vehicle according to the embodiment; and

FIG. 7 is a diagram showing a modification of the determination method of the location information and the moving direction of the vehicle according to the embodiment.

### DETAILED DESCRIPTION OF EMBODIMENTS

Embodiments of the present disclosure will be described below with reference to the drawings. It should be noted that, throughout all of the drawings, the same reference numerals are assigned to the same or corresponding parts. In addition, the present disclosure is not limited by the embodiments described below. Components in the following embodiments include those that are replaceable and easy for those skilled in the art, or those that are substantially the same.

First, problems studied by the present discloser in performing the present disclosure will be described. That is, according to the inventors' knowledge, the location information provided by a cellular network is tracking area (Tracking Area) based or cell (Cell) based. According to the tracking/cell-based technique, the functionality disclosed in TS23. 502 as defined by 3GPP allows the cellular network to provide location information to external application servers. The function disclosed in TS23. 502 includes, for example, a Nnef Event Exposure Subscribe, Unsubscribe and Notify function. The location information service (LCS: Location Services) provided by the cellular telephone communication network is specified in TS23 273 of 3GPP. However, the location information based on the tracking area and the cell area, for example, a traveling route such as a road in the travel of the vehicle, it is difficult to determine the traveling direction. For example, in a different vehicle located in the same cell, even when the traveling direction is on the opposite side or the same side, it is difficult to determine which traveling route different vehicles are traveling, tracking or cell-based techniques.

The reason for such a problem is that the location information service provided by the mobile phone communication network only measures the location of the user terminal (UE) at a predetermined location, and it is difficult to determine the travel path of the user terminal because the travel path is not taken into account. This is due to the fact that the service by the cellular telephone communication network is mainly correspondent to the human who possesses the user terminal, and the movement of the user terminal is also irregular and difficult to predict.

On the other hand, since there is a limitation that the vehicle runs in a traveling route such as a road provided in advance, irregular direction change like a human is hardly assumed. Therefore, the present discloser has focused on the point that it is easier to determine the direction of movement to some extent in the case of vehicle movement, as compared with the case of human movement. Further, in order to provide a service of a more sophisticated connected vehicle, without acquiring such travel information from the vehicle, the need to acquire by determining the moving direction of the vehicle is also increasing. For example, if a congestion cause occurs on a road shoulder, this congestion cause affects vehicles running on the same traveling route, i.e. the same road. Therefore, it is desirable to provide a service for simultaneously transmitting a message for calling attention to the occurrence of the cause of traffic congestion to a vehicle that is likely to be affected. That is, it may be necessary to distinguish between a vehicle that passes through a traveling route where the cause of traffic jam is occurring after the point of occurrence of the cause of traffic jam and other vehicles that already pass or run in the opposite direction of the opposite vehicle. By distinguishing these vehicles, it is possible to transmit messages of different urgency and priority between vehicles passing through a traveling route in which a traffic jam cause occurs after the time point of occurrence of the traffic jam cause and other vehicles. As a result, the driver of the vehicle can distinguish whether the warning message is a message with a high urgency or a normal message, and can respond appropriately easily.

Also, in the mobile phone communication network, it is possible to control the network resources (bandwidth and radio scheduler) to be transmitted in accordance with the urgency and priority. However, in cellular telecommunications networks, it has been extremely difficult to provide such advanced location information.

Therefore, in the present disclosure, first, topology information of base stations installed on roads is set based on design information and statistical information of each base station, and handover history between base stations of an in-vehicle communication module and topology information of the base stations are mapped. Thus, the present disclosure discloses a technique for deriving a road on which a vehicle is running and determining a traveling direction of the vehicle. The embodiments described below are based on the above intensive studies by the present discloser.

### (Information Processing System)

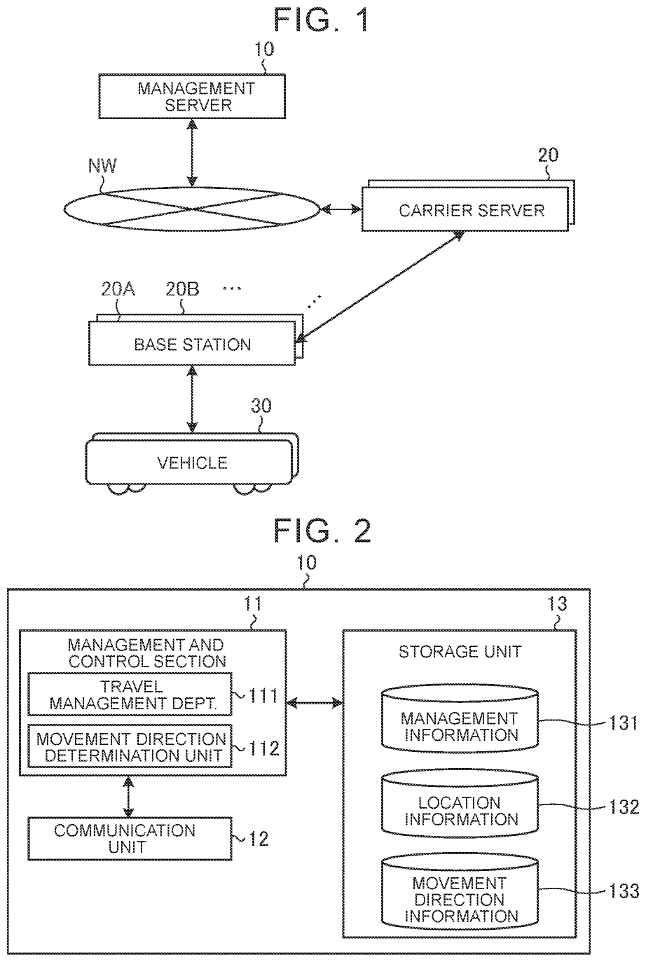

First, an information processing system according to an embodiment of the present disclosure will be described. As shown in FIG. 1, the information processing system 1 includes a management server 10 which is a vehicle management server, at least one communication carrier server 20, and at least one vehicle 30.

The management server 10, the communication carrier server 20, and the vehicle 30 are configured to communicate with each other through a network NW. The network NW is composed of, for example, an Internet network or a cellular telephone network (cellular network). The network NW may include, for example, another communication network such as a Wide Area Network (WAN), a telephone communication network such as a mobile telephone, a radio communication network such as WiFi (registered trademark), or the like. The network NW can support multicast broadcast communication. Network NW that conforms to standards such as the 3G Partnership Project (3GPP) can be adopted.

### (Management Server)

A management server 10 as an information processing device has a general computer configuration that can communicate via a network NW. The management server 10 acquires communication information such as the communication carrier server 20 and the base station 20A,20B, . . . , and manages running of the vehicles 30. In the present embodiment, various types of vehicle information 331 and travel information 332 are supplied from the respective vehicles 30 to the management server 10 at predetermined timings. Various communication information 333 is supplied to the management server 10 at a predetermined timing from the respective communication carrier servers 20, the base station 20A,20B, and so on. The management server 10 may be integrated with the communication carrier server 20 or may be a separate unit.

As shown in FIG. 2, the management server 10 as the second device includes a management control unit 11, a communication unit 12, and a storage unit 13. Specifically, the management control unit 11 as a second processor includes a processor such as a Central Processing Unit (CPU), Digital Signal Processor (DSP), or Field-Programmable Gate Array (FPGA) having hardware, and a main storage unit such as a Random Access Memory (RAM) or a Read Only Memory (ROM).

The communication unit 12 as an information-acquisition unit includes, for example, Local Area Network (LAN) interface boards, wireless communication circuits for wireless communication, and the like. The LAN interface board or the wireless communication circuit is connected to the network NW such as the Internet that is a public communication network. The communication unit 12 is connected to the network NW to communicate with the communication carrier server 20 and the vehicle 30. Communications unit 12, the communication unit 12, between the respective vehicles 30, or receives the vehicle identification information and travel information 332 unique to the vehicle 30 included in the vehicle information 331, or transmits an instruction signal to the vehicle 30. The vehicle identification information includes information for enabling each vehicle 30 to be individually identified.

The storage unit 13 includes a storage medium selected from an Erasable Programmable ROM (EPROM, a Hard Disk Drive (HDD), a removable medium, and the like. Examples of the removable medium include Universal Serial Bus (USB) memories, and disc recording media such as Compact Disc (CD), Digital Versatile Disc (DVD), or Blu-ray (registered trademark) Disc (BD). The storage unit 13 stores an operating system (OS), various programs, various tables, various databases, and the like.

The storage unit 13 stores an operating system (OS), various programs, various tables, various databases, and the like. The management control unit 11 loads the program stored in the storage unit 13 into the work area of the main storage unit and executes the program, and controls the respective components through the execution of the program. The program may be a learned model generated by, for example, machine learning such as deep learning. The learned model is also referred to as a learning model or simply as a model. Thus, the management control unit 11 can realize the functions of the travel management unit 111 and the movement direction determination unit 112. Details of the functions of the travel management unit 111 and the movement direction determination unit 112 will be described later.

The storage unit 13 stores management information 131, location information 132, and movement direction information 133, but the present disclosure is not limited thereto. The management information 131 includes various data for managing the vehicle 30. In the management information 131, the vehicle specific information of the vehicle information 331 and the travel information 332 may be stored in association with each other so as to be searchable.

### (Telecommunications Carrier Server)

The communication carrier server 20 is a server managed by a communication carrier that provides a network NW consisting of a core network consisting of a plurality of base stations 20A, 20B, . . . . The communication carrier server 20 is provided, for example, to a communication carrier or a network provider. Base stations 20A,20B, . . . include node B (NB) in Wide band Code Division Multiple Access (WCDMA (registered trademark), e node B (eNB) in LTE, or g node B (gNB) in NR, as defined by 3GPP.

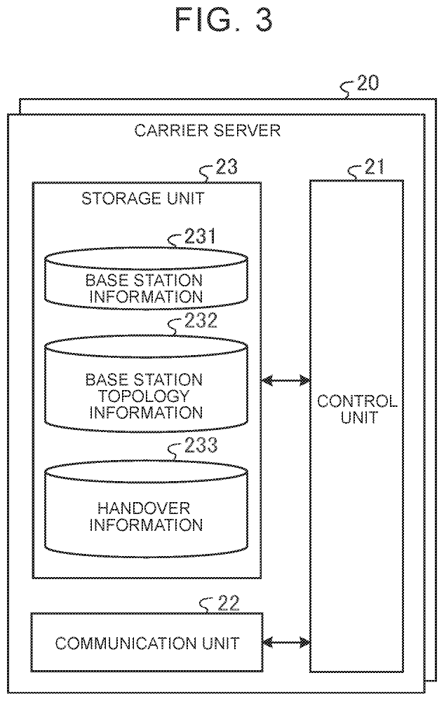

As shown in FIG. 3, the communication carrier server 20 as the first device includes a control unit 21 as a first processor, a communication unit 22, and a storage unit 23. The control unit 21, the communication unit 22, and the storage unit 23 are configured physically and functionally in the same manner as the management control unit 11, the communication unit 12, and the storage unit 13, respectively. The storage unit 23 as the first storage unit stores, for example, base station information 231, base station topology information 232, and handover information 233.

Base station information 231 includes information about base station 20A,20B, . . . . In the present embodiment, the base station information 231 includes information on roads included in a cell configured by the base stations 20A,20B, . . . The base station 20A, 20B is configured to be able to communicate with the respective vehicles 30 in the network NW of the mobile telephone communication network. The base station information 231 includes design information such as location information on roads included in locations where a plurality of base stations 20A,20B, . . . are installed and areas (cells) covered by the design information. The base station information 231 may include statistical information such as log information of base stations 20A,20B, . . . constituting the network NW.

The base station topology information 232 includes information of definitions according to the base station 20A,20B, . . . with respect to a traveling route on which the vehicle 30 can travel. For example, the traveling route of the vehicle 30 can be defined by the cell S1, which is the communication range of the base station 20A, and the cell S2, which is the communication range of the base station 20B. Here, the traveling route of the vehicle 30 is defined by the traveling route order of the base station 20A,20B, . . . which defines the cells including this traveling route. The traveling route of the vehicle 30 is defined by the base station 20A,20B, . . . and the order of passage of the cell, e.g., from the cell S1 of the base station 20A to the cell S2 of the base station 20B. The handover information 233 includes information on the handover history of the vehicles 30 and the base stations 20A,20B, . . . Hand Over (H/O) means, for example, switching the base stations 20A,20B, . . . communicating with the communication terminals (UEs) of the vehicles 30 while the communication terminals are moving.

### Vehicle

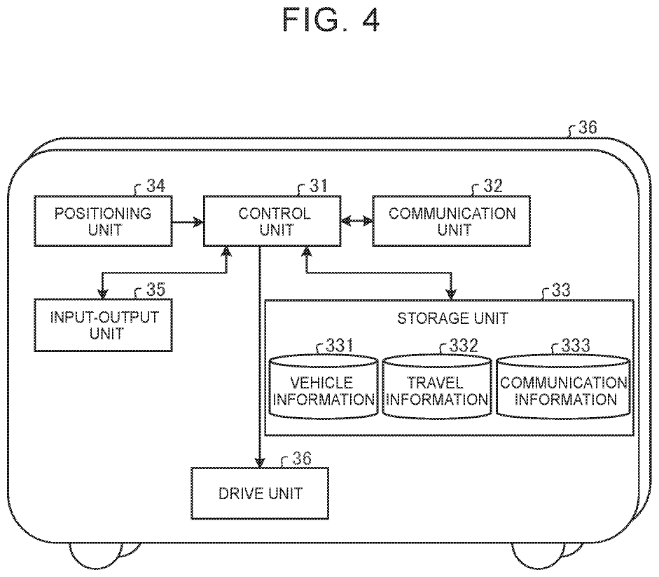

The vehicle 30 as a moving object is a vehicle which travels due to driver's driving or an autonomous traveling vehicle which can autonomously travel according to a given operation command. As shown in FIG. 4, the vehicle 30 includes a control unit 31, the communication unit 32, the storage unit 33, the positioning unit 34, the input-output unit 35, and the driving unit 36.

The control unit 31, the communication unit 32, and the storage unit 33 are functionally the same as the management control unit 11, the communication unit 12, and the storage unit 13 in the management server 10, respectively. The control unit 31 collectively controls operations of various constituent elements mounted on the vehicle 30. The communication unit 32 serving as a communication terminal of the vehicle 30 is composed of, for example, a Data Communication Module (DCM) or the like that performs communication with the base stations 20A, 20B, . . . and the management server 10 by radio communication via the network NW.

The storage unit 33 stores vehicle information 331, travel information 332, and communication information 333. The vehicle information 331 includes, but is not necessarily limited to, various information relating to the vehicle 30, such as, but not limited to, battery charge (SOC), fuel remaining, current location, in-vehicle status, vehicle dimensional information, and exterior conditions. Travel information 332, the location information, speed information, and the control unit 31 based on the information obtained from the positioning unit 34 and the driving unit 36 such as acceleration information moves of the vehicle 30 measured and generated, i.e. including various information relating to the travel, not necessarily limited to these information. The communication information 333 includes information on communication with the base stations 20A,20B, . . . of the respective cells by the communication unit 32, and information such as a handover history, but is not necessarily limited to these information. The vehicle information 331, the travel information 332, and the communication information 333 are stored in the storage unit 33 so as to be updatable. Vehicle information 331 and the travel information 332 is used for reading by the storage and control unit 31, it is also possible to a state not output to the outside.

Positioning unit 34 receives the radio waves from Global Positioning System (GPS) satellites to detect the location information of. Position and route of the vehicle 30 positioning unit 34 as a location information acquiring unit of the vehicle 30 is detected, as location information and traveling route information in the travel information, is retrievably stored in the vehicle information 331. As a method of detecting a position of the vehicle 30, a method in which Light Detection and Ranging or Laser Imaging Detection and Ranging (LiDAR) is combined with a three-dimensional digital map may be employed.

The input-output unit 35 is composed of a touch panel display, a speaker microphone, or the like. The input-output unit 35 as an output unit is configured to display characters, graphics, and the like on the screen of the touch panel display, output sound from the speaker microphone, and the like to notify predetermined information to the outside under the control of the control unit 31. Further, the input-output unit 35 serving as an input unit is configured to enable input of predetermined information to the control unit 31 by a user or the like to operate the touch panel display or emit sound toward the speaker microphone.

Incidentally, the vehicle 30 according to the present embodiment is provided with a positioning unit 34 and the input-output unit 35 as separate functions, instead of the positioning unit 34 and the input-output unit 35, having both the functions of the positioning unit 34 and the input-output unit 35, a communication function with the vehicle navigation system it may be provided with.

Drive unit 36 is a drive unit for driving necessary for running the vehicle 30. Specifically, the vehicle 30 includes an engine as a driving source. The engine is configured to be capable of generating electricity using an electric motor or the like by driving by combustion of fuel. The generated electric power charges a chargeable battery. The vehicle 30 includes a drive transmission mechanism transmitting drive force of the engine, drive wheels used for the vehicle to travel, and the like.

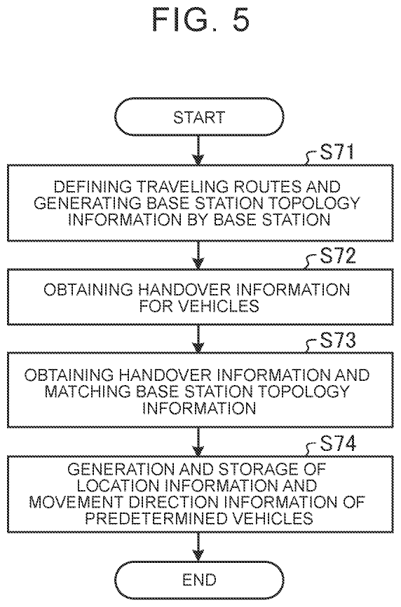

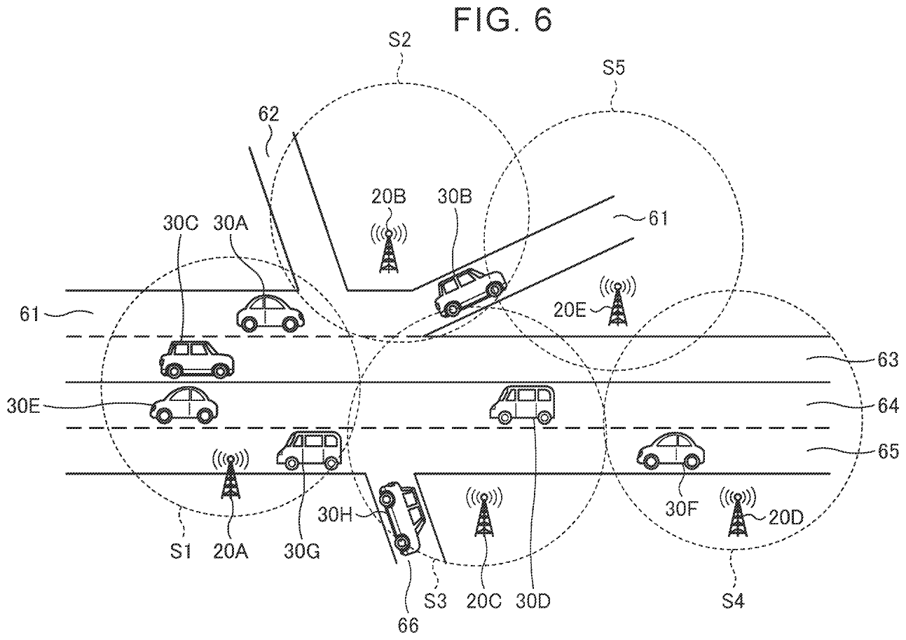

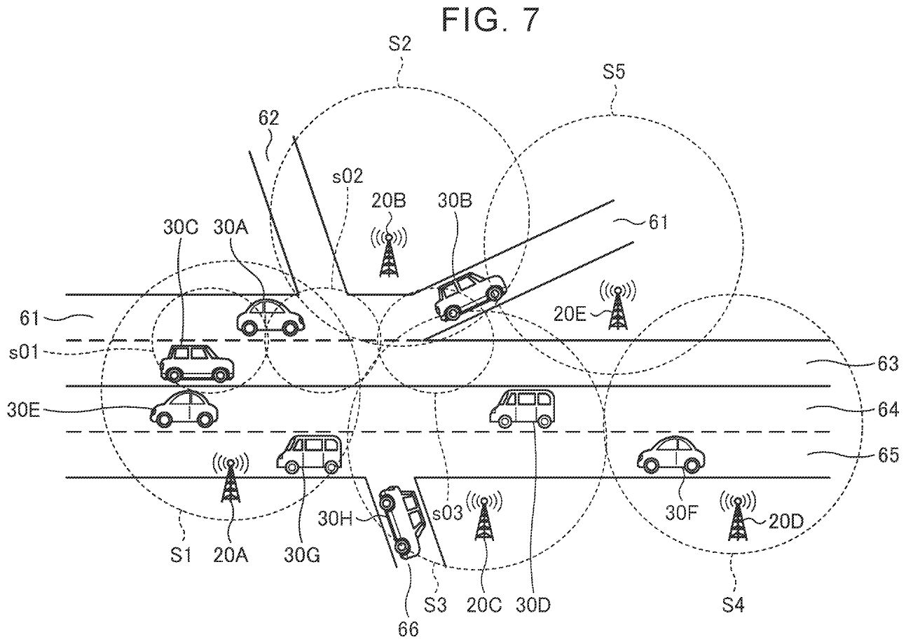

Next, a vehicle travel determination method according to the present embodiment, which is executed in the information processing system 1 configured as described above, will be described. FIG. 5 is a flowchart for explaining the driving determination method of the vehicle according to the present embodiment. FIG. 6 is a diagram for explaining a determination method of the location information and the moving direction of the vehicle according to the present embodiment.

As shown in FIG. 5, in step ST1, the management control unit 11 of the management server 10 generates definitions of traveling routes based on base station information 231 such as traveling routes 61 to 65 based on base station 20A,20B, . . . , and acquires base station topology information 232. The base station topology information 232 includes information of definitions and statistical information of the traveling routes 61 to 66.

That is, the control unit 11 defines and acquires the traveling route based on the base station information 231 of the base stations 20A,20B, . . . stored in the storage unit 23 of the communication carrier server 20. It should be noted that the control unit 11 may acquire, for example, information of defining a traveling route generated by an operator or other servers based on the base station information 231 relating to the base station 20A,20B, . . . , and the like in advance. The base station information 231 includes information related to the base station 20A,20B, . . . , design information, or statistical information acquired from a Network Function (NF) such as a Network Data Analytics Function (NWDAF, for example.

The control unit 11 may generate the definitions of the traveling routes 61 to 66 based on the information on the base station 20A,20B, . . . , the design information, or the statistical information acquired by analyzing the network data, such as NWDAF, by the mechanical learning, such as the deep learning, for example.

Here, the definition of the traveling routes 61-66 is defined as a series of nodes of a plurality of base station 20A,20B, . . . , covering this traveling road, and the like, the traveling road of the vehicle 30 such as the road. Specifically, for example, as shown in FIG. 6, the communication in the traveling routes 61 is covered by the respective cell S1, S2, S5 of the base station 20A,20B,20E. In this case, with respect to the communication in the vehicle 30A,30B traveling the traveling route 61 to the right in FIG. 6, the handover will be performed in the order of the cell S1 of the base station 20A, the cell S2 of the base station 20B, and the cell S5 of the base station 20E. Therefore, the traveling route 61 can be defined by the order of the base station 20A,20B,20E performing the handover and the order of the cell S1, S2, S5 covered by these base station 20A,20B,20E.

That is, for example, the traveling route 61 in which the vehicle 30A,30B is running can be defined as the order of the base station 20A (cell S1), the base station 20B (cell S2), and the base station 20E (cell S5) (S1→S2→S5). Travel route 62 flowing intersecting the traveling route 61 can be defined as the order (S2→S1→S3) of the base station 20B (cell S2), the base station 20A (cell S1), and the base station 20C (cell S3). Traveling route 63 in which the vehicle 30C is running can be defined as the order (S1→S3→S4) of the base station 20A (cell S1), the base station 20C (cell S3), and the base station 20D (cell S4). Traveling route 64 in which the vehicle 30D,30E travels in the opposite direction to the vehicle 30C can be defined as the order (S4→S3→S1) of the base station 20D (cell S4), the base station 20C (cell S3), and the base station 20A (cell S1). The traveling route 65 on which the vehicle 30F,30G travels in parallel with the traveling route 64 can also be defined in the same manner as the traveling route 64, and can be defined as the order (S4→S3→S1) of the base station 20D (cell S4), the base station 20C (cell S3), and the base station 20A (cell S1). Further, the traveling route 66 that branches from the traveling route 65 and the vehicle 30H travels can be defined as the order of the base station 20D (cell S4) and the base station 20C (cell S3) (S4→S3).

In this manner, the traveling routes 61-66 may be defined with a location based on cells S1-S5 covered by the plurality of base station 20A˜20E and a directionality based on the order of cells S1-S5. Although the traveling routes 61 to 66 are defined on the basis of the base station 20A to 20E and the cells S1 to S5 shown in FIG. 6, the traveling routes of the vehicle can be defined for every traveling route in which communication is covered by a base station provided on the road or a cell defined by the base station. In this way, the traveling route covered by the cell defined by the base station can be predefined as a series of connected nodes of the base station covering the traveling route. The base stations and cell order of the defined traveling routes 61-66 are included in the base station topology information 232 and stored in the storage unit 23 of the communication carrier server 20. The base station topology information 232 stored in the storage unit 23 of the communication carrier server 20 is introduced into the management information 131 by the management control unit 11 of the management server 10 and stored in the storage unit 13 as the management information 131.

Next, in step ST2, the communication carrier server 20 acquires the handover information 233 of each of the vehicles 30 from each of the base stations 20A,20B, . . . The handover information 233 of each vehicle 30 acquired by the control unit 21 of the communication carrier server 20 is stored in the storage unit 23. In addition, the travel management unit 111 of the management control unit 11 of the management server 10 acquires the history of the handover information 233 relating to each vehicle 30 from each communication carrier server 20. The management control unit 11 acquires the handover information 233 constantly, intermittently, or at a predetermined cycle. The travel management unit 111 stores the acquired handover information 233 in the storage unit 13 as the management information 131. That is, the management server 10 acquires the handover information 233 of the vehicle 30 from the base station 20A,20B such as AMF/MME and gNb/eNb. The management server 10 may directly acquire the handover information 233 from the base station 20A,20B, . . . Handover information 233 of the individual vehicle 30 includes historical information of switching of the base station 20A,20B, . . . with the movement of the vehicle 30.

Next, the process proceeds to step ST3, the movement direction determination unit 112 of the management control unit 11 compares the handover information 233 of each of the acquired vehicles 30 with the acquired base station topology information 232. Here, the handover information 233 includes information as to which cell S the vehicle 30 has passed in what order based on the cell S1,S2, . . . defined by the base stations 20A, 20B, . . . The base station topology information 232 includes information of the traveling routes 61 to 66 defined by the order of the cells S.

The movement direction determination unit 112 maps the information of the order of the cells S included in the handover information 233 for each vehicle 30 with the traveling routes 61 to 66 included in the base station topology information 232. Specifically, for example, referring to FIG. 6, the vehicle 30D is located in the base station 20C (cell S3), prior to switching, i.e., the handover source is the base station 20D (cell S4). Therefore, the base station topology information 232 is mapped based on the cell order S4→S3 in the vehicle 30D handover information 233, thereby extracting the traveling routes 64 and 65.

Further, the movement direction determination unit 112 may derive the following switching destinations of the base station 20A,20B, . . . of the vehicle 30D based on the base station topology information 232 relating to the extracted traveling routes 64 and 65. That is, the handover destination is the base station 20A (cell S1). Thus, the movement direction determination unit 112, the vehicle 30D can determine that the traveling routes 64 and 65, which are roads, are traveling leftward in FIG. 6. Therefore, based on the base station topology information 232 including the traveling routes 64 and 65, the movement direction determination unit 112 estimates the moving destination of the vehicle 30D and becomes predictable. Thus, the movement direction determination unit 112 can determine the traveling routes 61 to 66, such as the traveling roads of the vehicle 30, and the traveling directions, that is, the traveling directions of each vehicle 30, by mapping the handover information 233 in the individual vehicles 30 and the base station topology information 232 in association with each other.

According to the above-described procedure, the movement direction determination unit 112 determines the traveling routes 61 to 66 in which the vehicle 30 is traveling and the movement direction, and then proceeds to step ST4, and the management control unit 11 generates the location information 132 and the movement direction information 133 of the predetermined vehicle 30. The management control unit 11 stores the generated location information 132 and movement direction information 133 in the storage unit 13. Thus, the vehicle travel determination process according to the present embodiment is completed.

### Modification

Next, a modification of the embodiment will be described. FIG. 7 is a diagram showing a modification of the determination method of the location information and the moving direction of the vehicle according to the present embodiment.

As shown in FIG. 7, for example, with respect to the area where the first frequency band is used is a relatively low frequency band (e.g., the area of the primary cells S1 to S5), a relatively high frequency band, the first frequency band and the second frequency band is different there may be a plurality of secondary cells used. The first frequency band may be, for example, less than 3 GHz, specifically 800 MHz referred to as platinum band or golden band. The second frequency band, for example 3 GHz or more, specifically example, high frequency band and millimeter-wave band of the following frequency band 3 GHz or more 5 GHz used in the fifth-generation mobile communication system (5th Generation: 5G) or the like. In this instance, a network configuration may be considered in which the cells S1 to S5 in which the first frequency band is used include the cell s01, s02, s03 in which the second frequency band is used.

In this instance, in the same manner as in one embodiment, the cell s01,s02,s03 in which the second frequency is used can be used to define the traveling routes 61, 63, and the like. That is, for the same traveling routes 61 and 63, there may be a plurality of definitions of the traveling route by the first frequency and the definition of the traveling route by the second frequency. Specifically, for example, the traveling route 63 in which the vehicle 30C travels, in addition to the order of the primary cells S by the first frequency (S1→S3→S4), the order of the secondary cells s by the second frequency (s01→s02→s03) can be defined.

In this case, by acquiring both the handover information 233 in the primary cells S1 to S5 according to the first frequency band and the handover information 233 in the secondary cells s01 to s03 according to the second frequency band in the travel determination process according to one embodiment, it is possible to more accurately determine the location information and the movement direction information in the travel of the vehicle 30 by mapping the base station topology information 232 of the defined traveling routes 61 to 66 on the basis of the cells S1 to S5, s01 to s03 currently in service and the handover information 233.

By applying the above-described disclosure to Location Services (LCS) mechanism of 3GPP, the function of determining the traveling route and the road and orientation on which the vehicle 30 travels can be provided. That is, technical concepts may be added to 3GPP specification TS23. 502, specification TS23. 273, and others.

According to one embodiment of the present disclosure described above, based on the handover information 233 from the base station 20A,20B, . . . , the position and the direction of movement of the individual vehicles 30 can be determined to derive the location information and the movement direction information for each vehicle 30. As a result, it is also possible to predict the moving destination of each vehicle 30.

Although embodiments of the present disclosure have been specifically described above, the present disclosure is not limited to the embodiments described above, and various modifications based on the technical idea of the present disclosure and embodiments in which mutual embodiments are combined can be adopted. For example, the frequencies and road shapes listed in the embodiments described above are merely examples, and different frequencies and road shapes may be used as required.

For example, in the embodiment described above, depth learning using a neural network has been described as an example of machine learning, but machine learning based on other methods may be performed. For example, other supervised learning may be used, such as support vector machines, decision trees, simple Bayesian, k-neighborhood methods, etc. In addition, semi-supervised learning may be used instead of supervised learning. Further, as machine learning, reinforcement learning or deep reinforcement learning may be used.

### (Information Processing System)

In another embodiment, the function of the management server 10 may be added to the communication carrier server 20. It is also possible to add the function of the communication carrier server 20 to the management server 10. That is, as the information processing system, various system configurations are possible as long as the information processing system has the functions of the management server 10 and the communication carrier server 20.

### Recording Medium

In the above-described embodiment, a program capable of executing a processing method by the management server 10 or the communication carrier server 20 can be recorded on a recording medium readable by a computer or other machine or device. By causing a computer or the like to read and execute a program of the recording medium, the computer or the like functions as a control unit of the management server 10 or the communication carrier server 20. Here, the recording medium that is readable by the computer or the like indicates a non-transitory recording medium in which information such as data or a program is accumulated through electrical, magnetic, optical, mechanical, or chemical action and from which the information can be read by the computer or the like. Examples of such recording media that can be removed from a computer and the like include a flexible disk, a magnetic-optical disk, a CD-ROM, CD-R/W, Digital Versatile Disk (DVD), a BD, a DAT, a magnetic tape, a memory card such as a flash memory, and the like. Examples of a recording medium fixed to the computer or the like include a hard disk and a ROM. Furthermore, the SSD can be used as a removable recording medium such as a computer or as a recording medium fixed to a computer or the like.

### Other Embodiments

In the management server 10 and the communication carrier server 20 according to the embodiment, the “unit” described above can be read as a “circuit” or the like. For example, the communication unit can be replaced with a communication circuit.

Further, a program to be executed by the management server 10 or the communication carrier server 20 according to an embodiment may be stored in a computer connected to a network such as the Internet and may be provided by downloading via a network.

In the description of the flowcharts in this specification, the context of processing among steps is clearly indicated using expressions such as “first,” “after,” “next,” and the like; however, the order of processing necessary for implementing the present embodiment is not uniquely determined by these expressions. That is, the order of processing in the flowchart described herein can be varied to the extent that there is no inconsistency.

Alternatively, instead of a system including a single server, edge computing technology may be applied in which a terminal capable of executing processing of a part of the server is distributed in a location physically close to the information processing device, and a large amount of data can be efficiently communicated and the computing processing time can be shortened.

Further effects or modification examples may be easily derived by a person skilled in the art. A wider aspect of the present disclosure is not limited to the specific details and the representative embodiments which have been represented and described as mentioned above. Therefore, the present disclosure may be variously modified without departing from the spirit of the scope of the concept of the generative disclosure defined by the accompanying claims and equivalents thereto.

What is claimed is:

1. An information processing device comprising a processor that:
acquires base station topology information in a base station that communicates with a vehicle in a traveling route of the vehicle based on at least one of design information and statistical information of the base station; and
associates handover information between a communication unit provided in the vehicle and the base station with the base station topology information defining the traveling route along which the vehicle moves, and determines location information and movement direction information of the vehicle.

2. The information processing device according to claim 1, wherein the base station topology information includes information defining the traveling route along which the vehicle moves in accordance with an order of a plurality of cells covered by a plurality of the base stations.

3. The information processing device according to claim 1, wherein the handover information in the vehicle includes information on a history of switching of a plurality of the base stations switched as the vehicle moves.

4. The information processing device according to claim 1, wherein the base station topology information includes information on an order of a plurality of primary cells that performs communication using a first frequency band and information on an order of a plurality of secondary cells that performs communication using a second frequency band.

5. The information processing device according to claim 4, wherein an area of the secondary cell using the second frequency band is smaller than an area of the primary cell using the first frequency band.

6. The information processing device according to claim 4, wherein the first frequency band is a frequency band of less than 3 GHz, and the second frequency band is a frequency band of 3 GHz or more.

7. The information processing device according to claim 1, wherein the processor acquires the handover information periodically or intermittently.

8. An information processing system comprising:
a first device provided with a first storage unit that stores base station topology information including base station information relating to a base station that communicates with a vehicle in a traveling route of the vehicle and information defining the traveling route along which the vehicle moves based on at least one of design information and statistical information included in the base station information, and a first processor that acquires handover information between the base station and a communication unit provided in the vehicle and stores the handover information in the first storage unit; and
a second device provided with a second processor that acquires the base station topology information and the handover information from the first storage unit of the first device, associates the handover information with the base station topology information, and determines location information and movement direction information of the vehicle.

9. The information processing system according to claim 8, wherein the base station topology information includes information defining the traveling route along which the vehicle moves in accordance with an order of a plurality of cells covered by a plurality of the base stations.

10. The information processing system according to claim 8, wherein the handover information in the vehicle includes information on a history of switching of a plurality of the base stations switched as the vehicle moves.

11. The information processing system according to claim 8, wherein the base station topology information includes information on an order of a plurality of primary cells that performs communication using a first frequency band and information on an order of a plurality of secondary cells that performs communication using a second frequency band.

12. The information processing system according to claim 11, wherein an area of the secondary cell using the second frequency band is smaller than an area of the primary cell using the first frequency band.

13. The information processing device according to claim 11, wherein the first frequency band is a frequency band of less than 3 GHz, and the second frequency band is a frequency band of 3 GHz or more.

14. The information processing system according to claim 8, wherein the processors acquire the handover information periodically or intermittently.

15. A non-transitory storage medium storing a program that causes a processor to:
acquire base station topology information in a base station that communicates with a vehicle in a traveling route of the vehicle based on at least one of design information and statistical information of the base station; and
associate handover information between a communication unit provided in the vehicle and the base station with the base station topology information defining the traveling route along which the vehicle moves, and determine location information and movement direction information of the vehicle.

16. The storage medium according to claim 15, wherein the base station topology information includes information defining the traveling route along which the vehicle moves in accordance with an order of a plurality of cells covered by a plurality of the base stations.

17. The storage medium according to claim 15, wherein the handover information in the vehicle includes information on a history of switching of a plurality of the base stations switched as the vehicle moves.

18. The storage medium according to claim 15, wherein the base station topology information includes information on an order of a plurality of primary cells that performs communication using a first frequency band and information on an order of a plurality of secondary cells that performs communication using a second frequency band.

19. The storage medium according to claim 18, wherein an area of the secondary cell using the second frequency band is set smaller than an area of the primary cell using the first frequency band.

20. The storage medium according to claim 15, wherein the program causes the processor to acquire the handover information periodically or intermittently.
